(19) United States
(12) Patent Application Publication
(10) Pub. No.: US 2003/0035911 A1
(43) Pub. Date: Feb. 20, 2003

(54) Multi-layer insulating material

(76) Inventors: Dieter Krist, Winnenden (DE); Bernd Hanel, Fellbach (DE)

Correspondence Address: PEARNE & GORDON LLP, 526 SUPERIOR AVENUE EAST, SUITE 1200, CLEVELAND, OH, 44114-1484, US

(21) Appl. No.: 10/205,280

(22) Filed: Jul. 25, 2002

(30) Foreign Application Priority Data
Jul. 25, 2001 (DE) 101 36 269.2

(51) Int. Cl. B32B 1/08

(52) U.S. Cl. 428/36.5; 428/36.91

(57) ABSTRACT

A multi-layer insulating material is described for pipes which are designed for the conducting of fluids of higher temperature, said multi-layer insulating material having an inner layer part made of a temperature resistant and/or non-combustible and flexible material of pre-determinable thickness and an outer layer part made of foam material which has a lower temperature resistance in comparison with the inner layer part.

The invention relates to a multi-layer insulating material, in particular a hose-shaped insulating material for pipes which are designed for the conducting of fluids of higher temperature. The invention furthermore relates to a method of manufacturing such a multi-layer insulating material.

Hose-shaped insulating materials for pipes are known in different designs. In the case of pipes conducting hot water in building plumbing, a flexible foam material is frequently used as the insulating material which is, optionally, surrounded on the outside by a thin protective cover in order to prevent damage to the foam material where possible. These known insulating materials are not suitable to satisfy their insulating function in long-term operation if the temperature of the fluids conducted in the respective pipes clearly exceeds the limiting values such as are usually pre-determined for process water lines or heating feed lines, An example for pipes with a much higher temperature load is represented by pipes which are used in connection with solar collectors. Such pipes can reach temperatures well above 200° C.

It is the object of the invention to provide an insulating material which is also suitable for pipes with a high temperature load and which can be processed, in particular also pulled onto the pipes in question, without problem and ensures the required insulating properties in the long term.

This object is substantially satisfied in accordance with the invention by an inner layer part which is formed in one or more layers and is made of a material which is at least temperature resistant and/or non-combustible and whose thickness or radial dimension is selected in dependence on the temperature of the pipe surface and by an outer layer part which is formed in one or more layers and is made of a foam material. having a temperature resistance which is lower in comparison with the inner layer part.

The demands of practice with respect to the insulating properties, the handling capability and, above all, also the economic efficiency are fully taken into account by this design of the insulating material.

Both the inner layer part and the outer layer part can be made both of one layer and of a plurality of layers, with the individual layers being able to have different material. properties in particular in connection with the inner layer part. A first part layer can, for example, have a particularly high temperature resistance at the radial inner side and part layers can follow at the radial outside which have to be selected in dependence on, for example, flexibility and strength.

The thickness, or the radial dimension, of the inner layer part is selected in dependence on the surface temperature of the pipe, which typically lies in the range from 7.20° C. to 250° C. The thickness, or the radial dimension, preferably increases proportionally to the rising temperature; however, non-proportional relations, in particular also in dependence on the materials used, are also possible between the temperature and the thickness, or the radial dimension.

Flexible materials are preferably used both for the inner layer part and for the outer layer part; however, in dependence on the respective application, it is also conceivable to use pre-pressed and dimensionally stable glass fiber shells, rock wool shells and the like, i.e. the use of semi-hard or even hard insulating materials is possible, with the total insulation of a pipe also being able to be composed of non-flexible and flexible sections.

The inner layer part and the outer layer-part, or part layers, are preferably connected to one another by heat fixing with or without additional materi ; als such as an adhesive film, liner powder and the like.

A variant of the invention is characterized in that a spacing material is provided at least between the inner layer part and the outer layer part to form. a narrow air gap, or uneven surfaces are formed between the layer parts, such that air gaps and/or air inclusions are formed in this manner. This embodiment can have particularly advantageous effects both with respect to the required insulating properties and with respect to the handling properties of the insulating material.

In accordance with a further embodiment of the invention the inner layer part comprises a tear resistant layer, which is preferably the most inner layer, wherein said layer may be formed as an additional layer and/or as a mesh fabric or textile fabric. This provides the advantage that the insulating material is protected against damages by a tube or pipe when providing the tube or pipe with the insulating material.

Further particularly advantageous embodiments of the invention are set forth in the dependent claims and will be explained with reference to the drawing in connection with the description of embodiments; there are shown in the drawing:

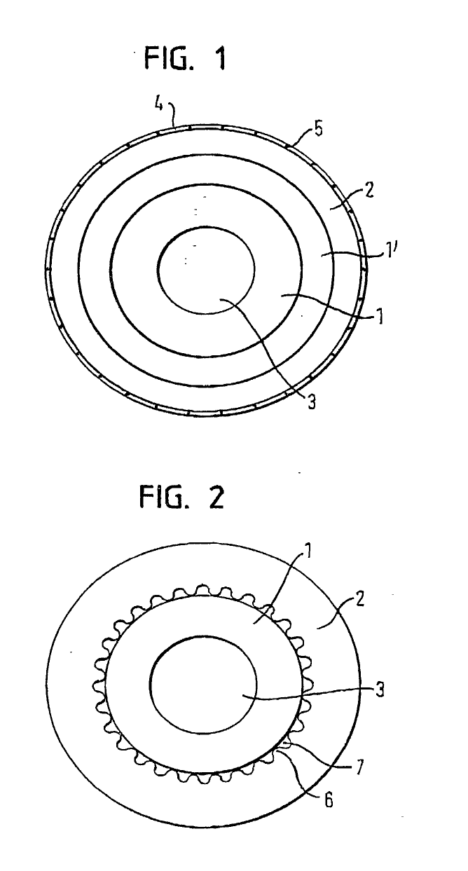

FIG. 1 a schematic cross-sectional view of a first embodiment of a multi-layer insulating material in, accordance with. the invention; and

FIG. 2 a schematic cross-sectional representation of a second variant.

In accordance with FIG. 1, the hose-shaped, multi-layer insulating material consists of an inner layer part 1, 1′, which has two layers in this case, and a single layer outer layer part 2 which adjoins this in the radial direction. The central receiving space 3 for the respective pipe is preferably dimensioned such that the respective pipe can be inserted with low clearance and/or that the hose-shaped insulating material can be pulled onto, the respective pipe without problem, and indeed also over corresponding pipe bends.

The inner layer part 1, 1′ and the outer layer part 2 can be fixed in their mutual positions by simple friction engagement; however, a heat fixing, with and without additional materials such as an adhesive film, liner powder or the lake, is also possible.

Whereas at least one radially inwardly lying part layer for the inner part layer 1, 1′ consists of a heat resistant and non-combustible elastomer foam, a melamine foam or a mineral fiber material, polyethylene foam., polypropylene foam, elastomer foam, polystyrene foam and the like is used for the outer layer part 2, as is also the case with insulating materials which are not exposed to any special heat strains. A temperature resistance of up to approximately 100° C. is sufficient for these materials and a material of much lower temperature resistance can also be used if a corresponding radial temperature lowering is achieved due to the design of the inner layer part.

The outer layer part 2, which can be made less flexible and more dimensionally stable in comparison with the inner layer part, is preferably made laminatable and covered with a colored or transparent, and above all tear resistant film 4, with a mesh network also being able to be integrated into this film 4 for a further increase in the tear resistance. The mesh 5 can also be disposed at the inner side of the lining film 4.

FIG. 2 shows a variant having a central receiving space 3 for the respective pipe, an inner layer part ]. and an outer layer part 2, with the outer layer; part 2 being provided at the inner side with grooves extending in the longitudinal direction and with air passages 7 of small radial dimension being formed thereby between the outer layer part 2 and the inner layer part 7. The depth of the grooves, or air gaps, in the outer layer part 2 is disposed in the region from approximately 1 to 5 mm, and the groove peaks 6, which contact the inner layer part 1 inside the insulating material, are somewhat compressed in their height due to the light strain between the inner layer part 1 and the outer layer part 2.

The radial thickness of the inner layer part and the outer layer part 2 is selected in dependence on the required insulating properties, on the one hand, and on the materials used, or their insulating properties, on the other hand. The provision of air gaps in the layer design has an advantageous effect both with respect to the insulating properties which can be achieved and with respect to the handling properties of the insulating material.

In the manufacture of the insulating material in accordance with the invention, the layers used can be combined successively or in one working step to form an insulating material composite. In addition to the use of the co-extrusion technology, it is possible in particular and in a technologically simple mariner to shape at least individual layers of the hose-shaped insulating material in the course of the production from a substantially planar plate material and to build up the respectively desired insulating material composite successively in this manner.

### Reference Numeral List

1, 1′ inner layer part

2 outer layer part

3 pipe receiving space

4 lining film

5 mesh

6 groove peak

7 air passage

1. A multi-layer insulating material, in particular a hose-shaped insulating material for pipes which are designed for the conducting of fluids of higher temperature,
characterized by an inner layer part (1, 1′) formed in one or more layers and made of an at least temperature resistant and/or non-combustible material whose thickness, or radial dimension, is selected in dependence on the temperature of the pipe surface; and an outer layer part (2) formed in one or more layers and made of a foam material with a lower temperature resistance in comparison with the inner layer part (1, 1′).

2. An insulating material in accordance with claim ], characterized in that the outer layer part (2) consists of a dimensionally stable, and simultaneously flexible, foam material,

3. An insulating material in accordance with, claim 1, characterized in that the thickness, or the radial dimension, of the inner layer part (1, 1′) is selected in particular increasing proportionally to the temperature of the pipe surface in the range from approximately 120° C. to approximately 250° C.

4. An insulating maternal in accordance with any one of claims 1 to 3, characterized in that the inner layer part (1, 1′) consists of a sezaihard to hard insulating material, in particular-of pre-pressed glass fiber shells or rock wool shells or the like.

5. An insulating material in accordance with any one of claims 1 to 3, characterized in that the inner layer part (1, 1′) consists of a temperature resistant, flexible material.

6. An insulating material in accordance with claim 5, characterized in that the inner layer part (1, 1′) consists of at least one layer of in particular an elastomer foam (EPDM mixture), a melamine foam, a mineral fiber or the like.

7. An insulating material in accordance with claim 1, characterized in that the outer layer part (2) consists of at least one layer of a polyethylene foam, a polypropylene foam, an elastomer foam, a polystyrene foam and the like, with the outermost layer preferably carrying at the outer side a strong protective layer or protective coating (4), in particular in the form of a film of polyethylene with a mesh fabric (5) of textile fabric and the like.

8. An insulating material in accordance with claim 1, characterized in that the inner layer part (1, 1′) has a temperature resistance of more than 200° C.

9. An insulating material in accordance with any one of the preceding claims, characterized in that the inner layer part (1, 1′) consists of at least one extruded hose.

10. An insulating material in accordance with any one of the preceding claims, characterized in that the inner layer part (1, 1′) consists of at least one plate material shaped into a hose during manufacture.

11. An insulating material in accordance with any one of the preceding claims, characterized in that the inner layer part (1, 1′) and the outer layer part (2) are connected to one another by frictional engagement.

12. An insulating material in accordance with any one of the preceding claims, characterized in that the outer layer part (2) is made laminatable and is surrounded by a watertight and/or weatherproof and/or in particular also tear resistant film (4).

13. An insulating material in accordance with any one of the preceding claims, characterized in that the inner layer part (1, 1′) is connected to the outer layer part (2) by heat fixing with or without additional materials such as an adhesive film, linen' powder and the like.

14. An insulating material in accordance with any one of the preceding claims, characterized in that a spacing material designed to form a narrow air gap is provided between the inner layer part (1, 1′) and the outer layer part (2).

15. An. insulating material in accordance with any one of the preceding claims, characterized in that the outer layer part (2) has an uneven surface at the inner side and air gaps and/or air inclusions are thereby formed between the outer layer part (2) and the inner layer part (1, V).

16. An insulating material in accordance with any one of the preceding claims, characterized in that the outer layer part (2) is provided at the inner side with grooves extending in the longitudinal direction or in the peripheral direction and open and/or closed air passages (7) of small radial dimension are thereby formed between the outer layer part (2) and the inner layer part (1).

17. An insulating material in accordance with claim 16, characterized in that the depth of the grooves or of the air gaps in the outer layer part (2) lies in the range from 1 to 5 mm and the groove peaks (6) contact the inner layer part (1, 1′) inside the insulating material and are slightly compressed in their height.

18. An insulating material in accordance with any one of the preceding claims, characterized in that, instead of the inside of the outer layer part (2), the outside of the inner layer-part (1, 1′) is made uneven, in particular grooved.

19. An insulating material in accordance with, any one of the preceding claims, characterized in that the radial thickness of the inner layer part (1, 1′) is equal to or larger than the radial thickness of the outer layer part (2).

20. An insulating material in accordance with claim 1, characterized in that the inner layer part (1, 1′) comprises a tear resistant layer which is preferably arranged as the most inner layer and which may be formed as an additional layer and/or as a mesh fabric or textile fabric.

21. A method of manufacturing a multi-layer insulating material in accordance with any one of the preceding claims, characterized in that the two materials of the inner layer part (1, 1′) and the outer layer part (2) are combined to form, an insulating material composite in one working step.

22. A method of manufacturing a multi-layer insulating material in accordance with any one of claims 1 to 19, characterized in that the materials of the inner layer part (1, 1′) and the outer layer part (2) are combined successively to form an insulating material composite.

23. A method in accordance with claim. 21, characterized in that at least one layer part is shaped from a substantially planar plate material to form a hose part.
